(19) United States
(12) Patent Application Publication
(10) Pub. No.: US 2015/0262096 A1
(43) Pub. Date: Sep. 17, 2015

(54) METHOD OF ENHANCING MANAGERIAL EFFECTIVENESS AND ORGANIZATIONAL SUSTAINABILITY

(71) Applicant: Viktor HADJIEV, Burnaby (CA)

(72) Inventor: Viktor Hadjiev, Burnaby (CA)

(21) Appl. No.: 14/435,172

(22) PCT Filed: Oct. 11, 2012
(86) PCT No.: PCT/CA2012/050715

§ 371 Date: Apr. 13, 2015

(51) Int. Cl. G06Q 10/06

(52) U.S. Cl. CPC G06Q 10/0637

(57) ABSTRACT

Cognitive topology is a business methodology enhancing managerial effectiveness and organizational sustainability. It is a system of cognitive indicators, which enables an organization to form managerial goals, initiate strategic changes and optimize managerial/organizational performance. This is achieved by determining the level of compatibility between the activities going in three main managerial perspectives human relations, work environment and managerial processes, on the one hand, and the particulars of the business situation, on the other hand. Behavioral features and characteristics are assigned a key place in creating Cognitive topology. They are the methodological nucleus, which enables the formation of managerial competencies and approaches that lead to optimal behavior and sustainable outcomes in business.

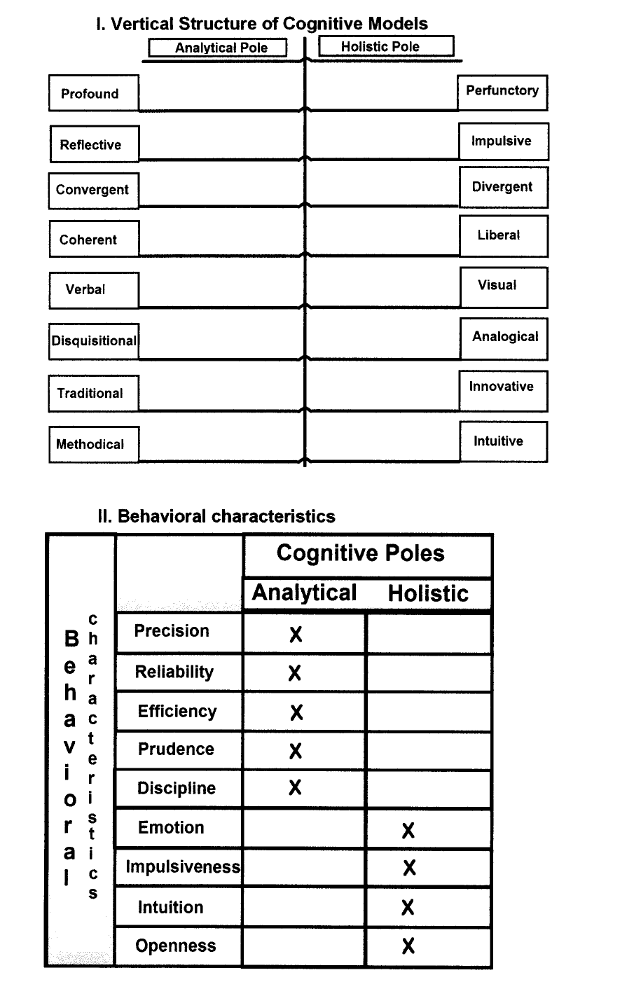

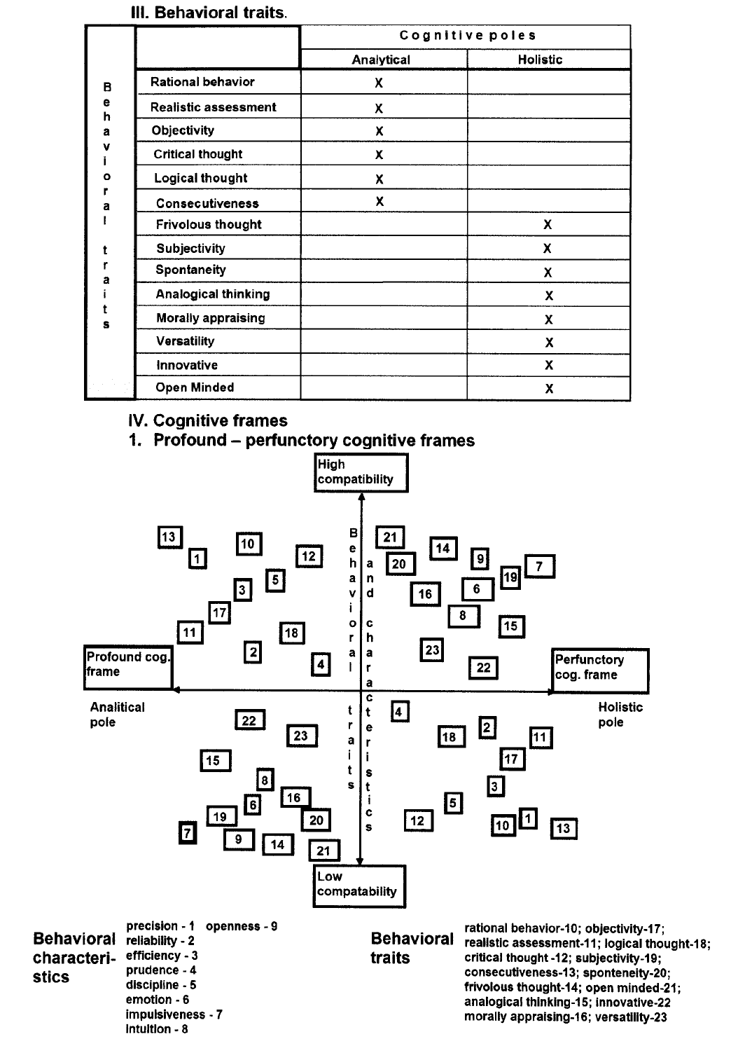

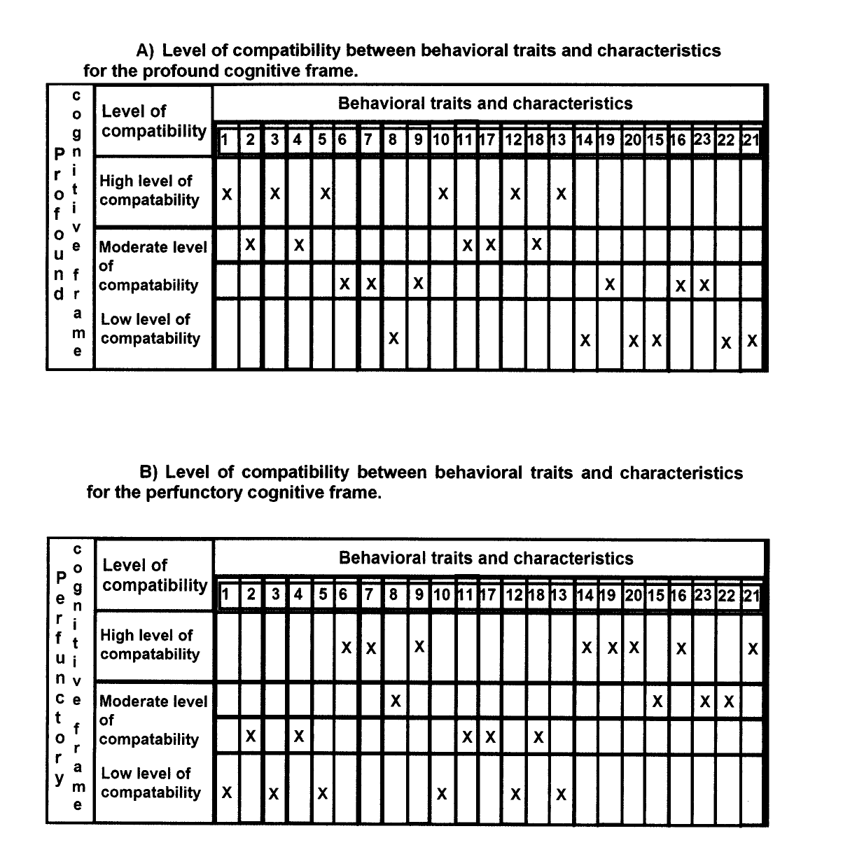

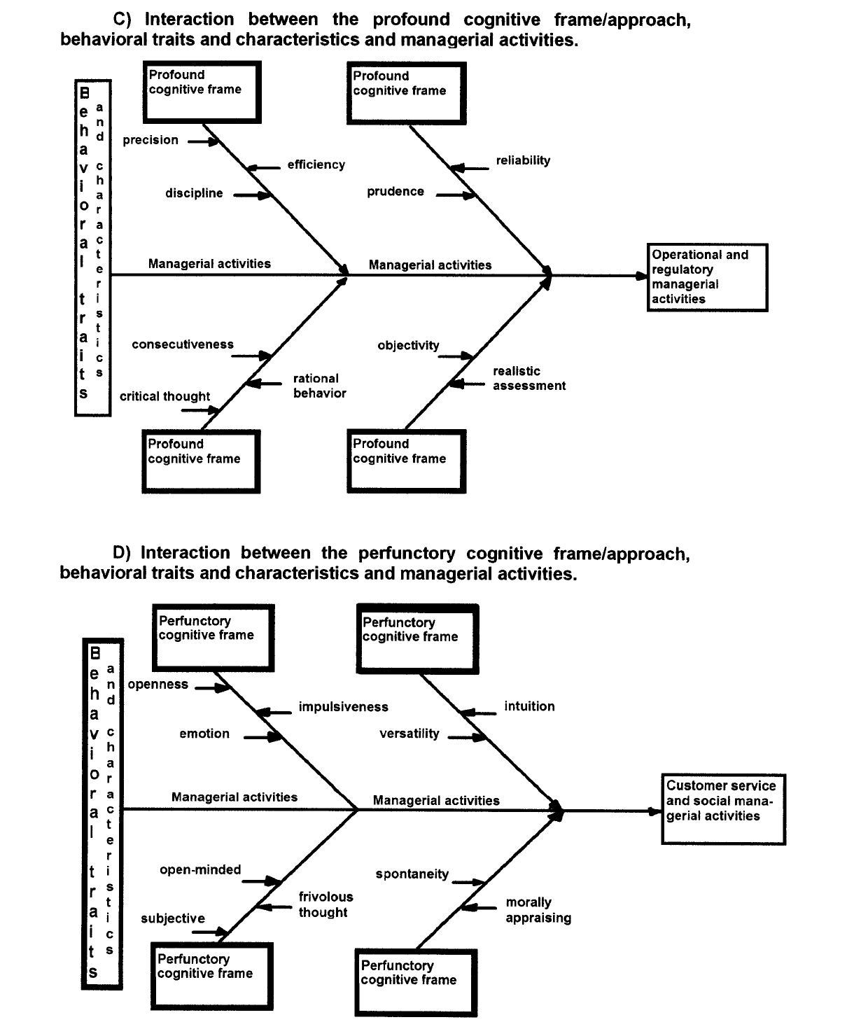

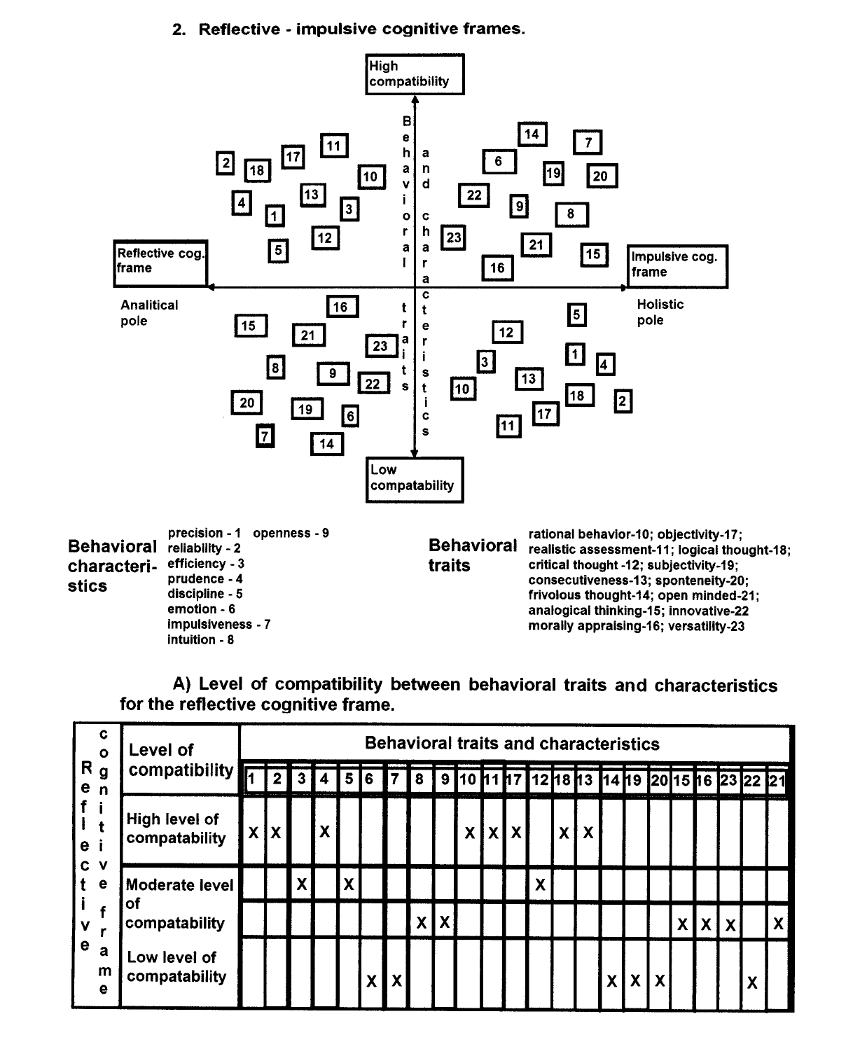

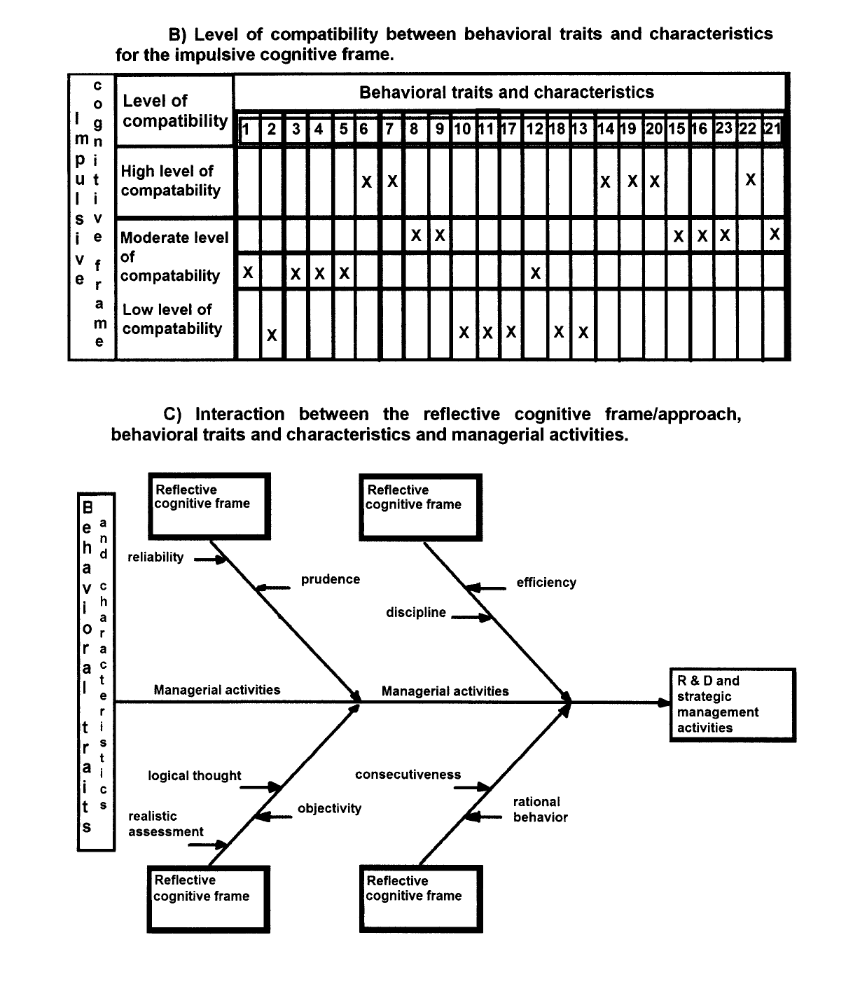

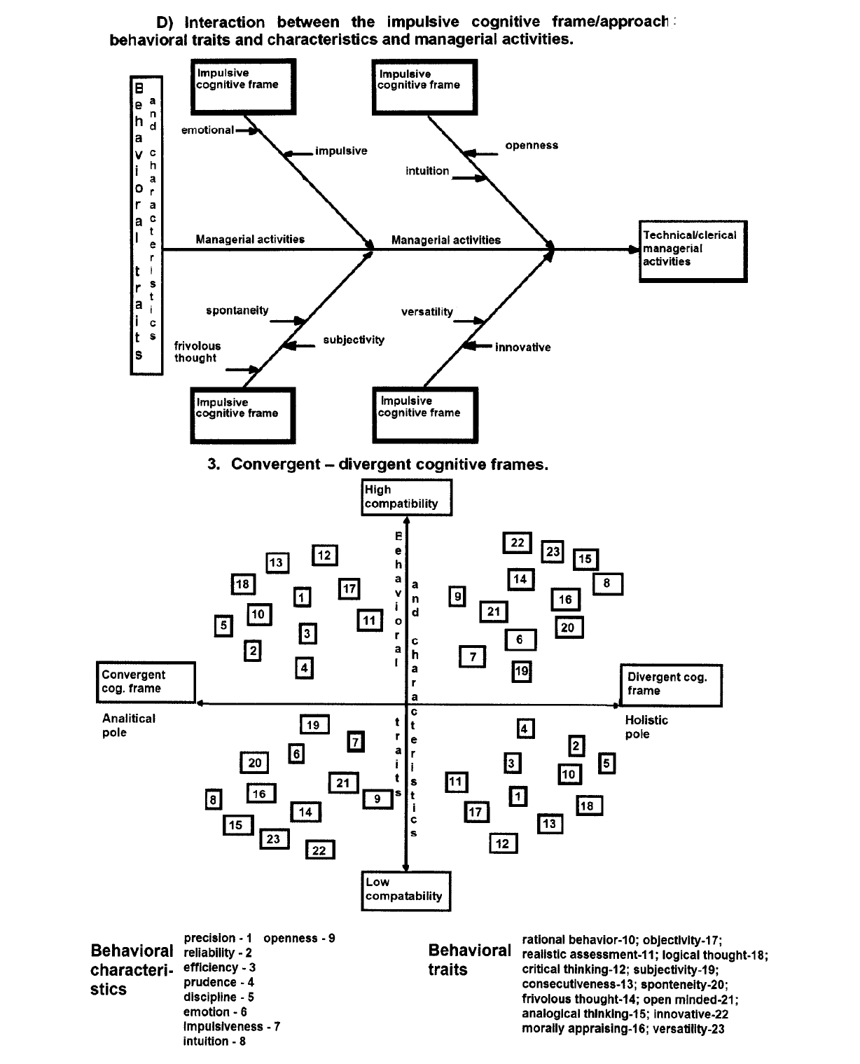

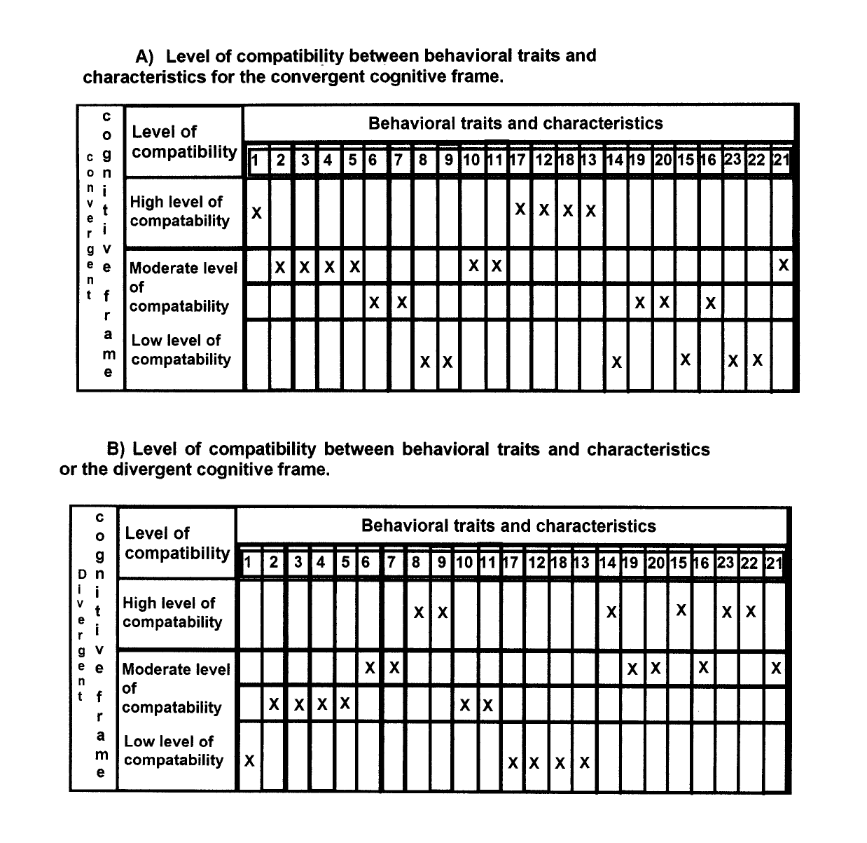

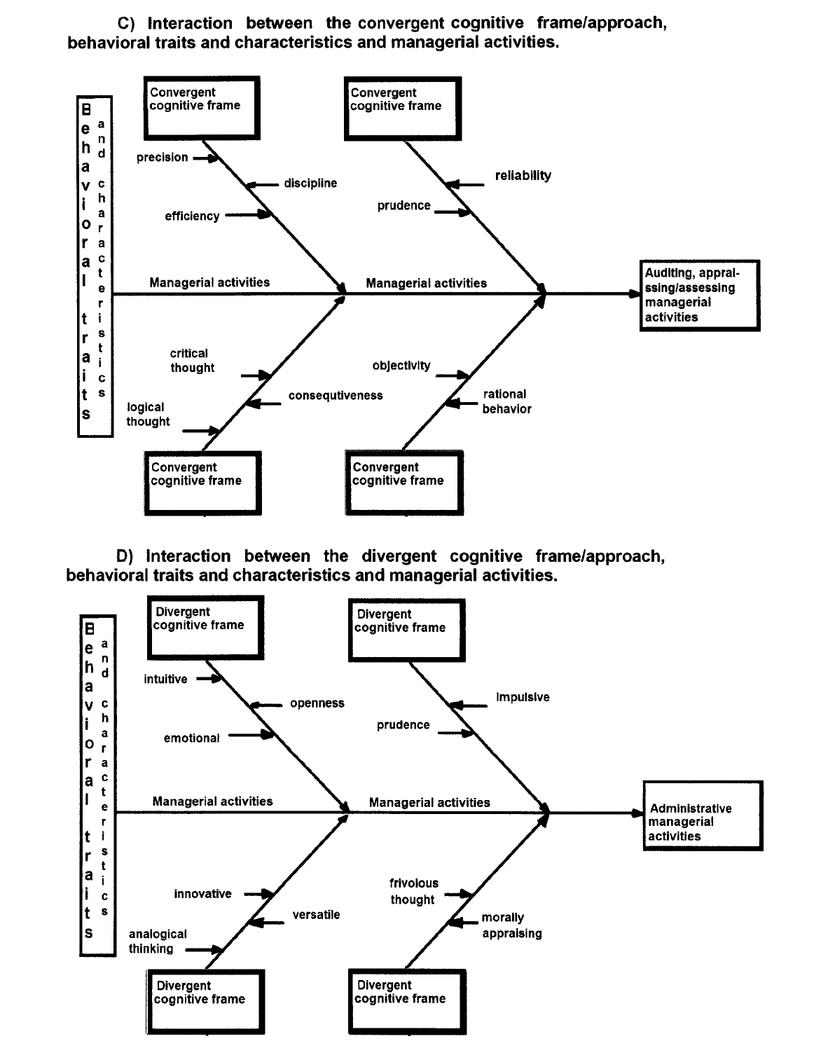

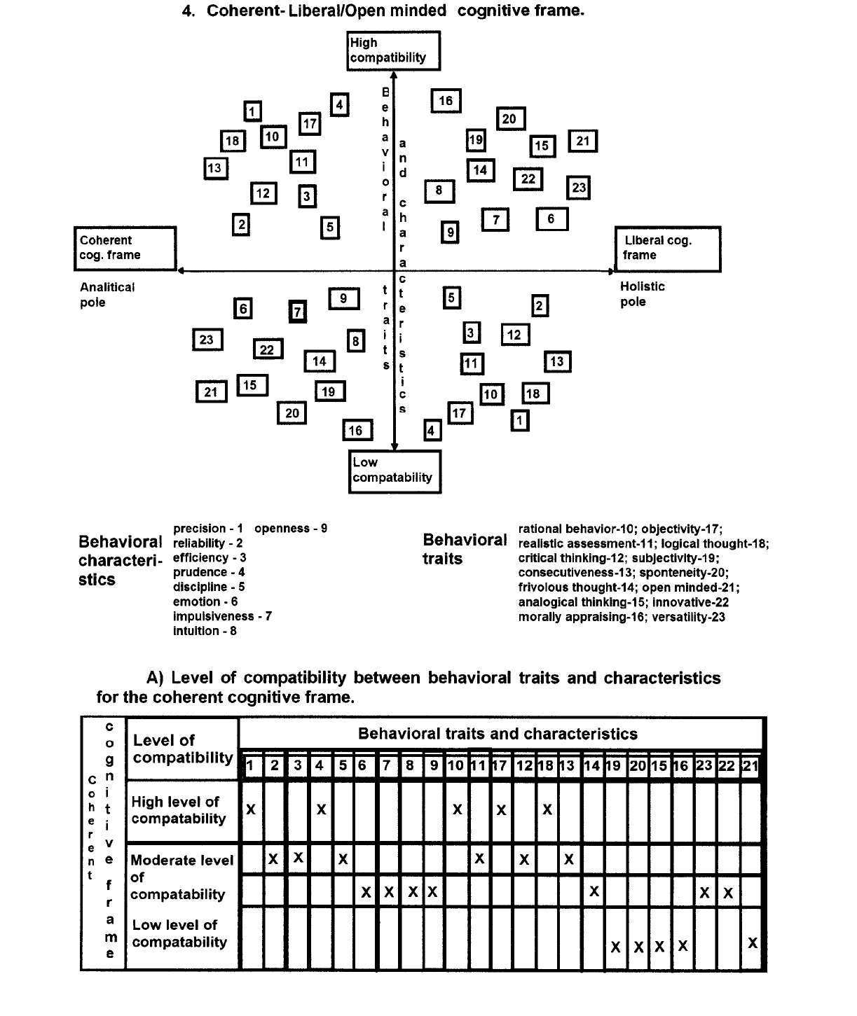

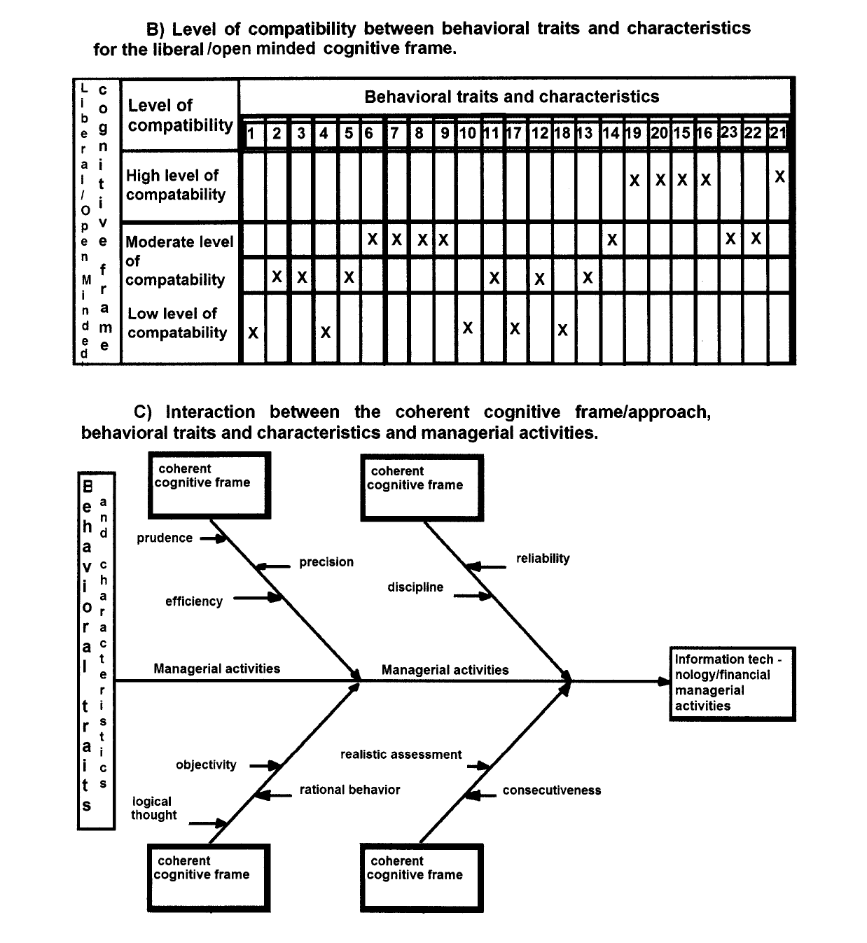

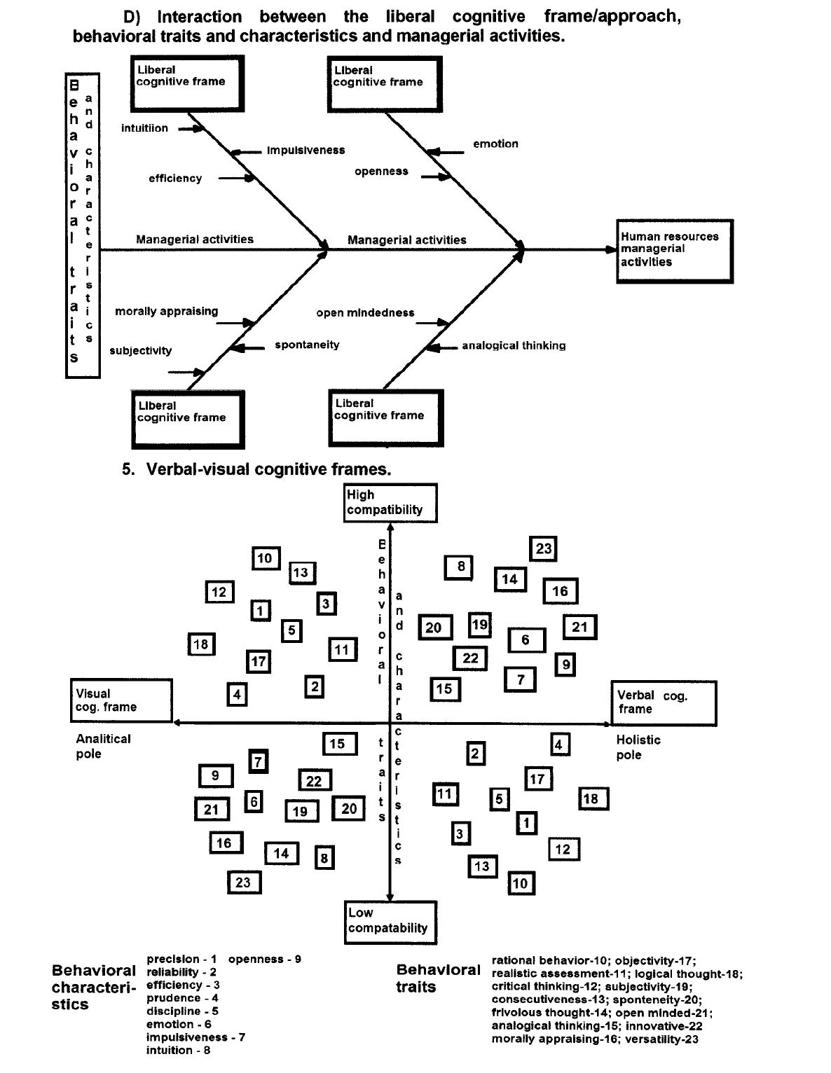

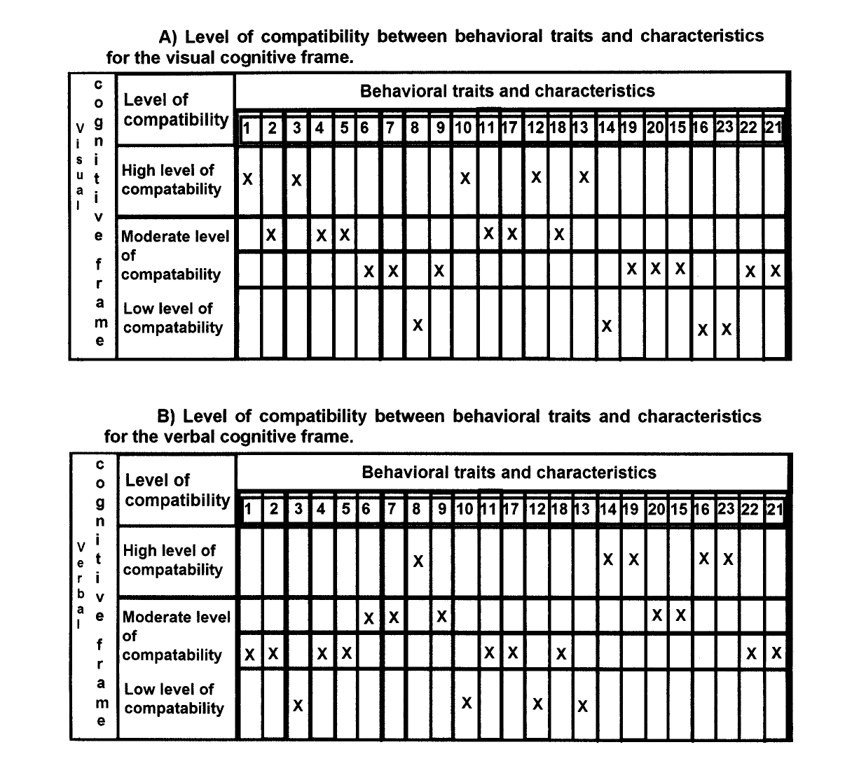

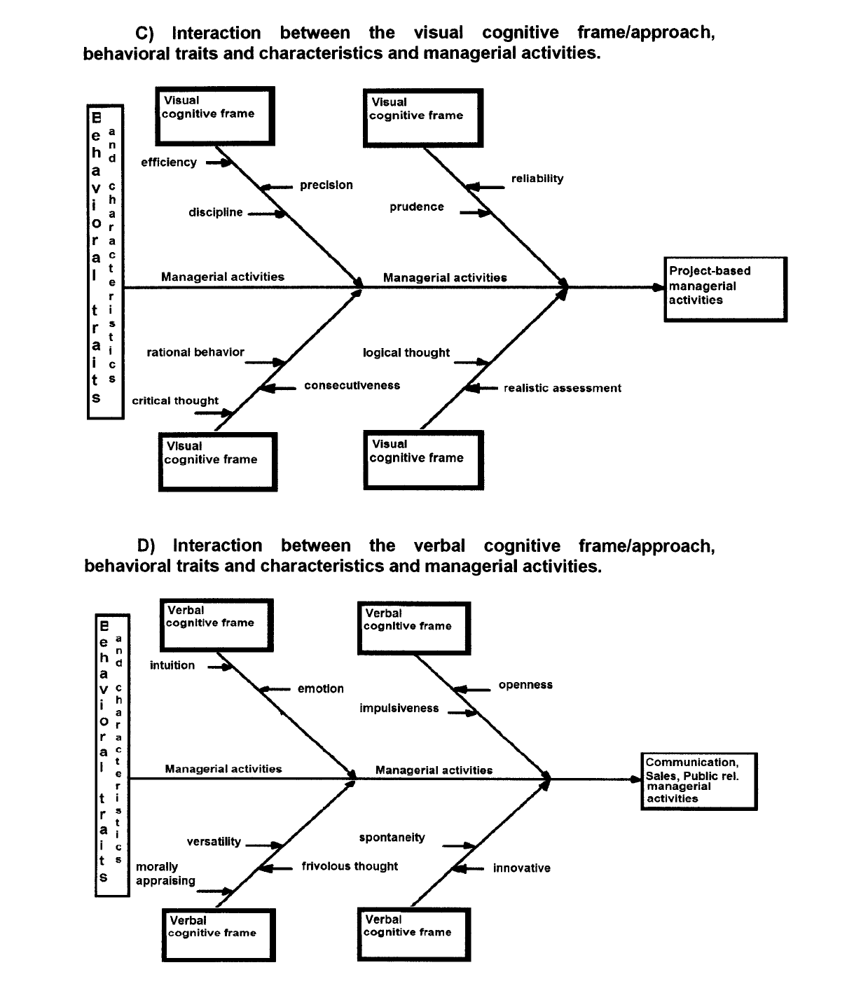

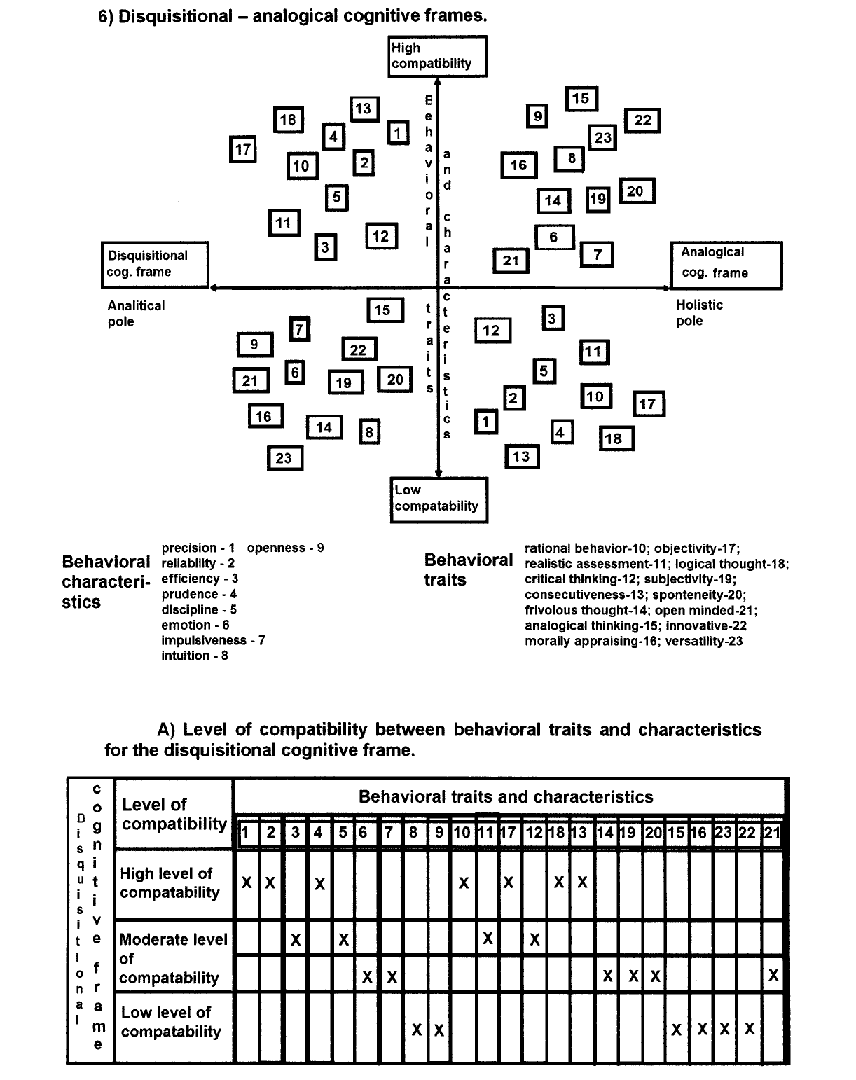

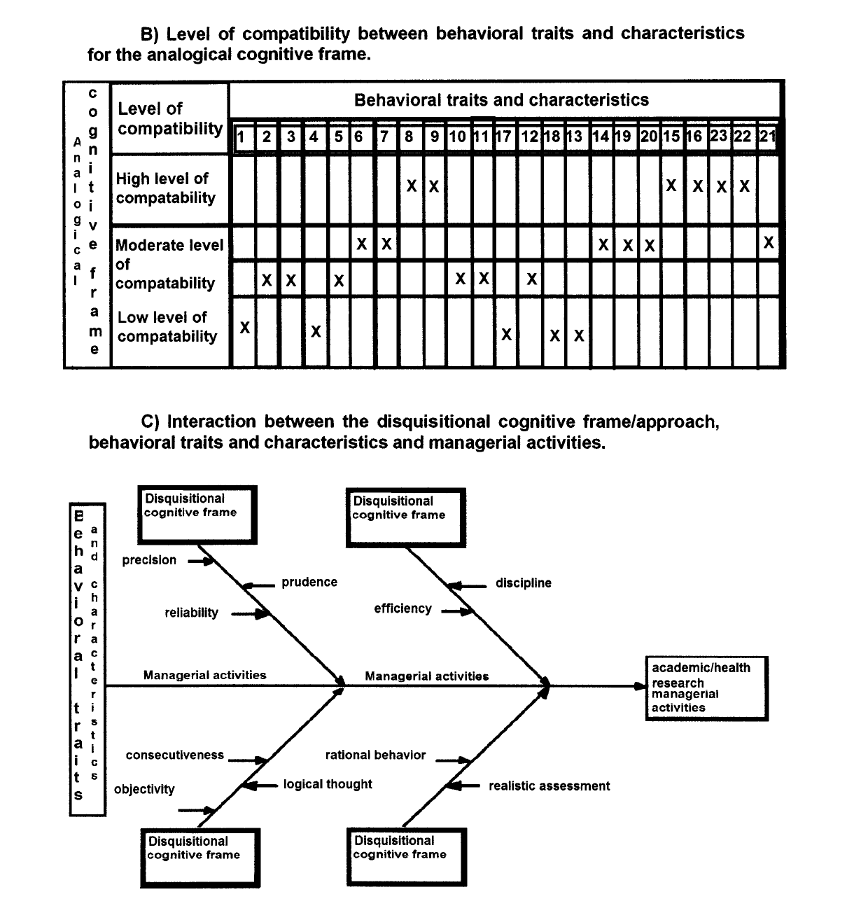

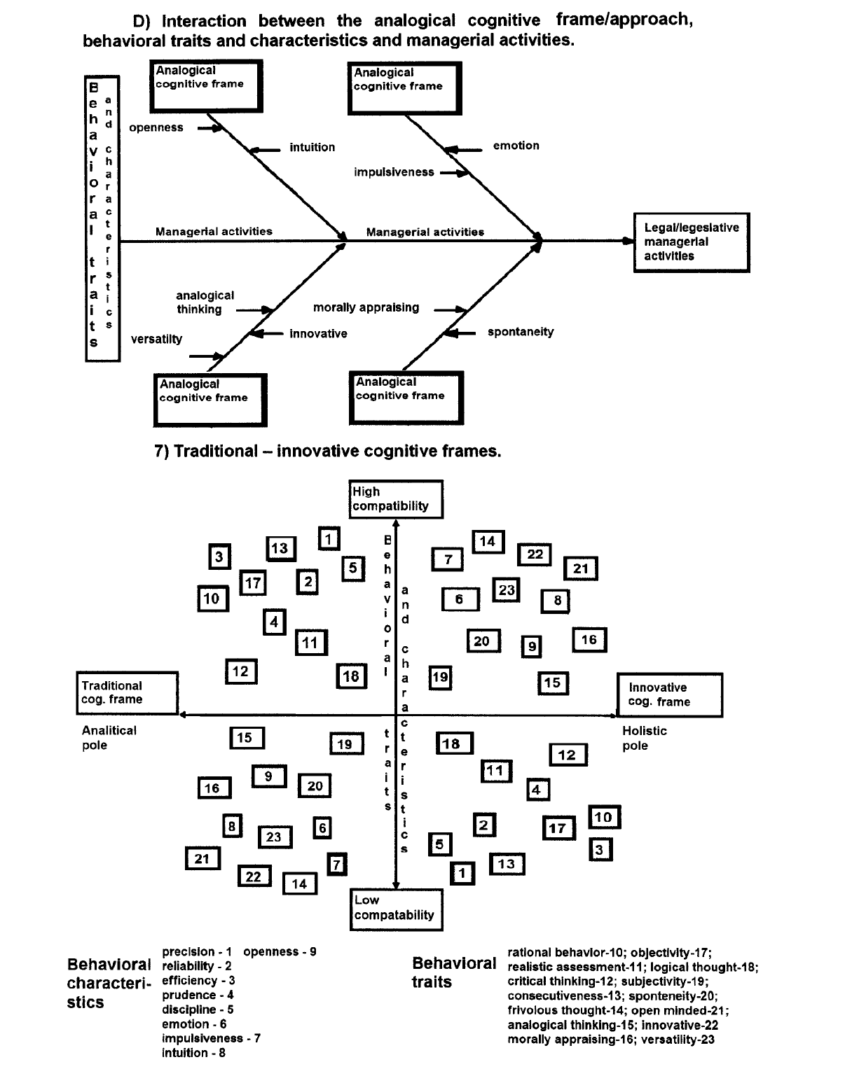

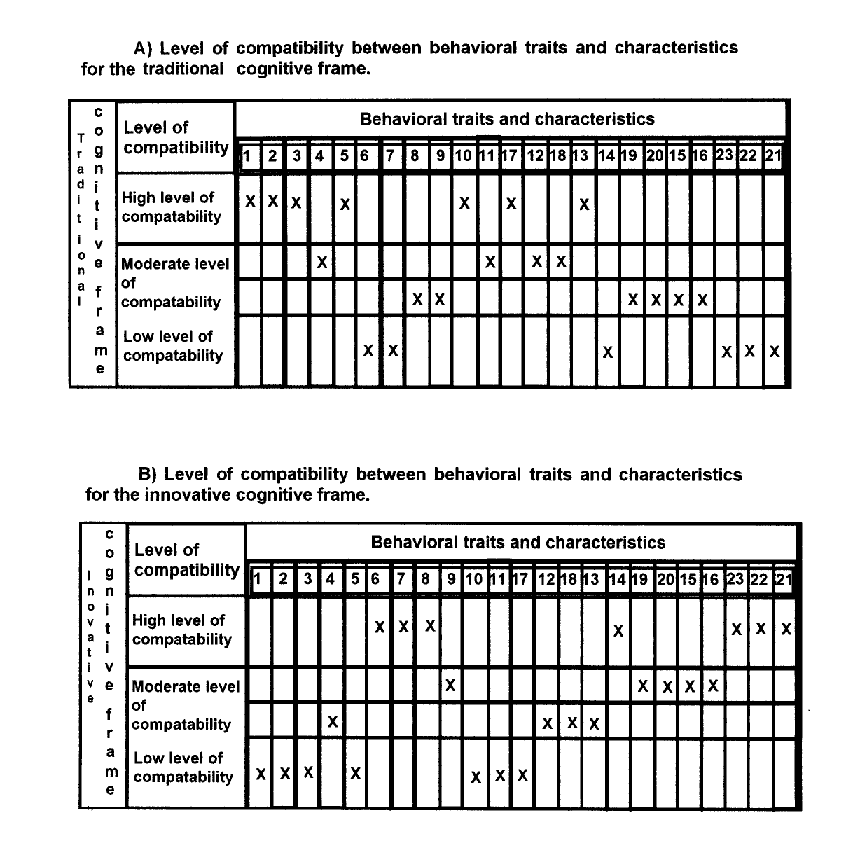

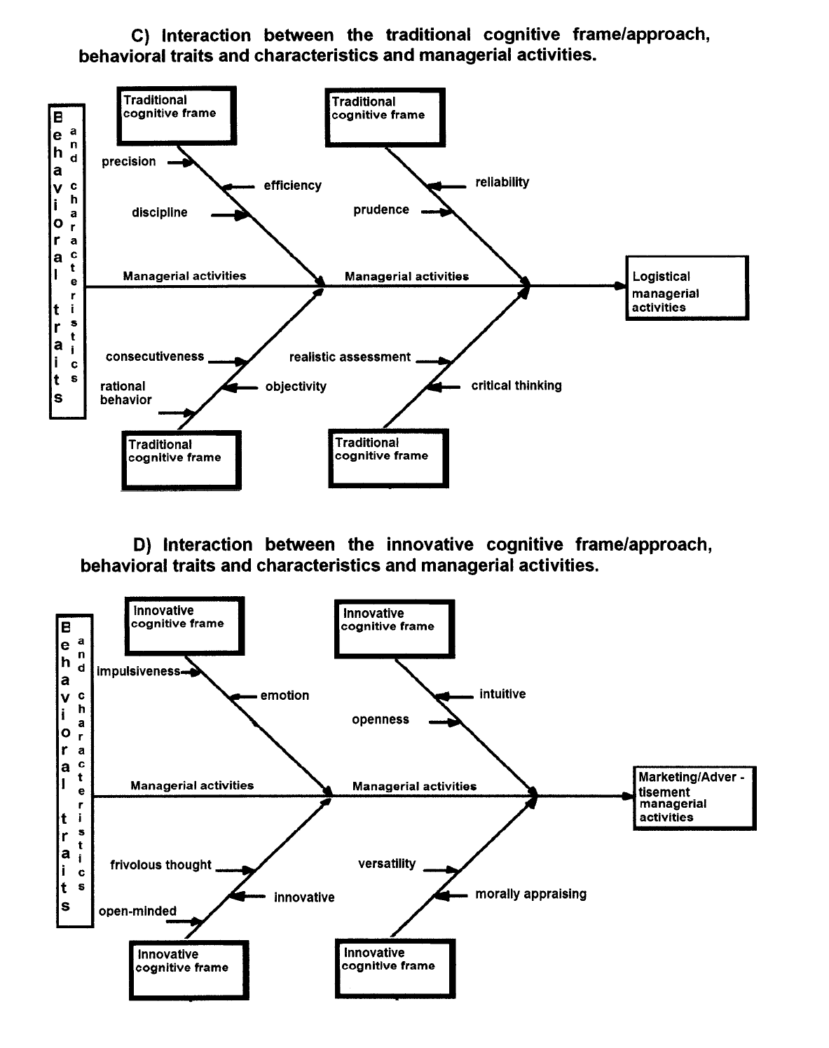

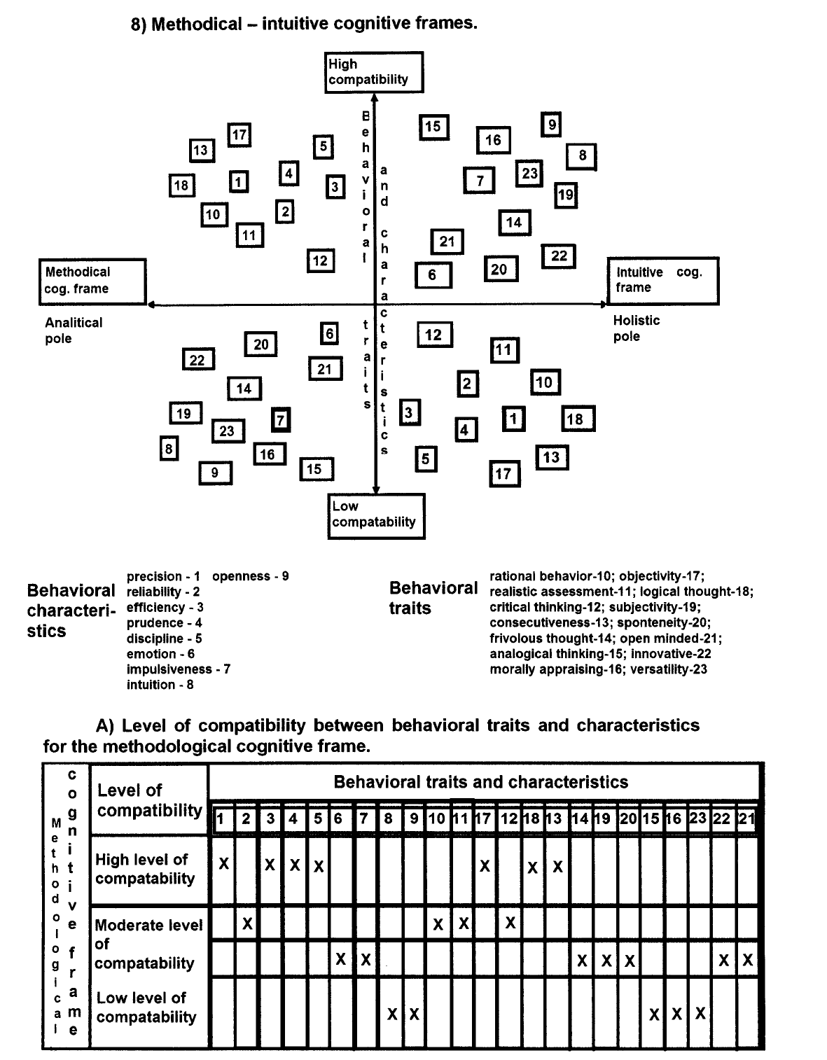

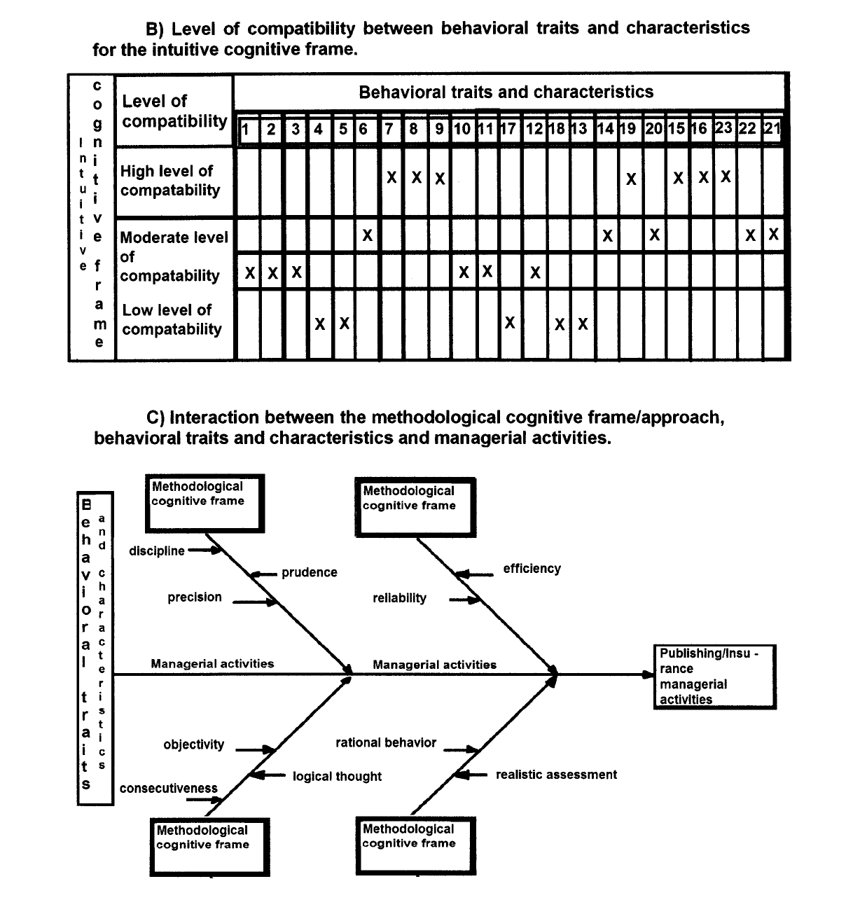

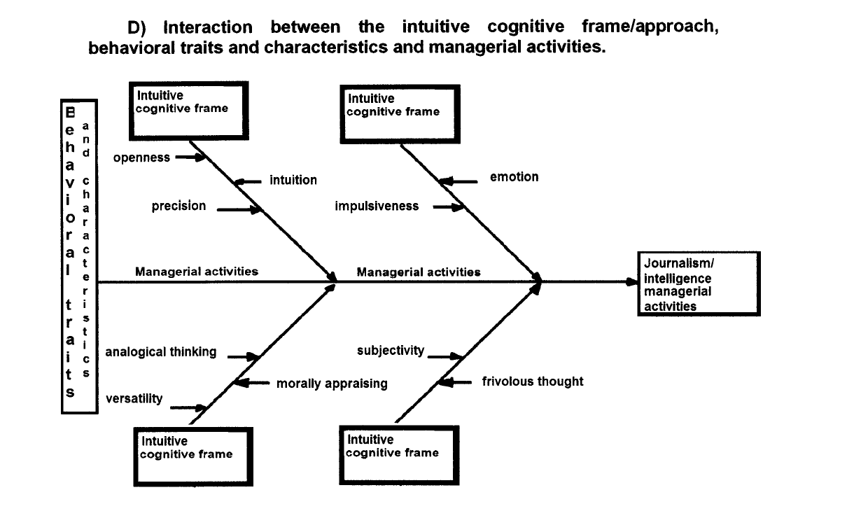

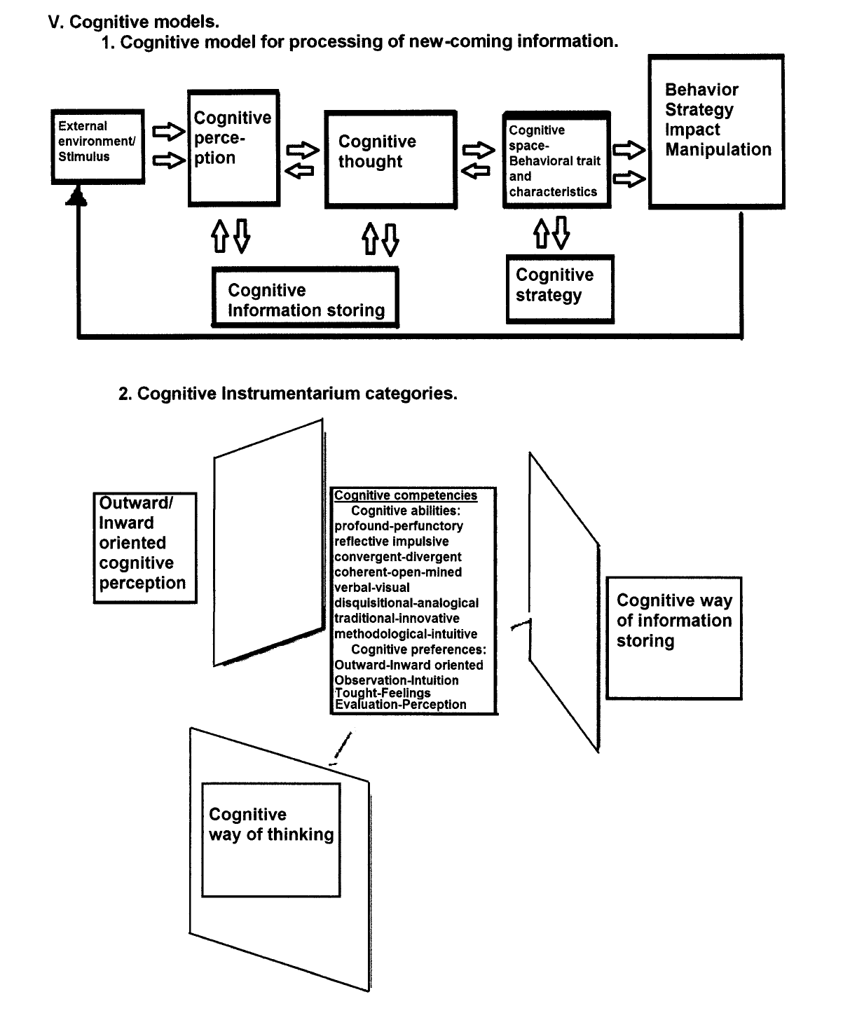

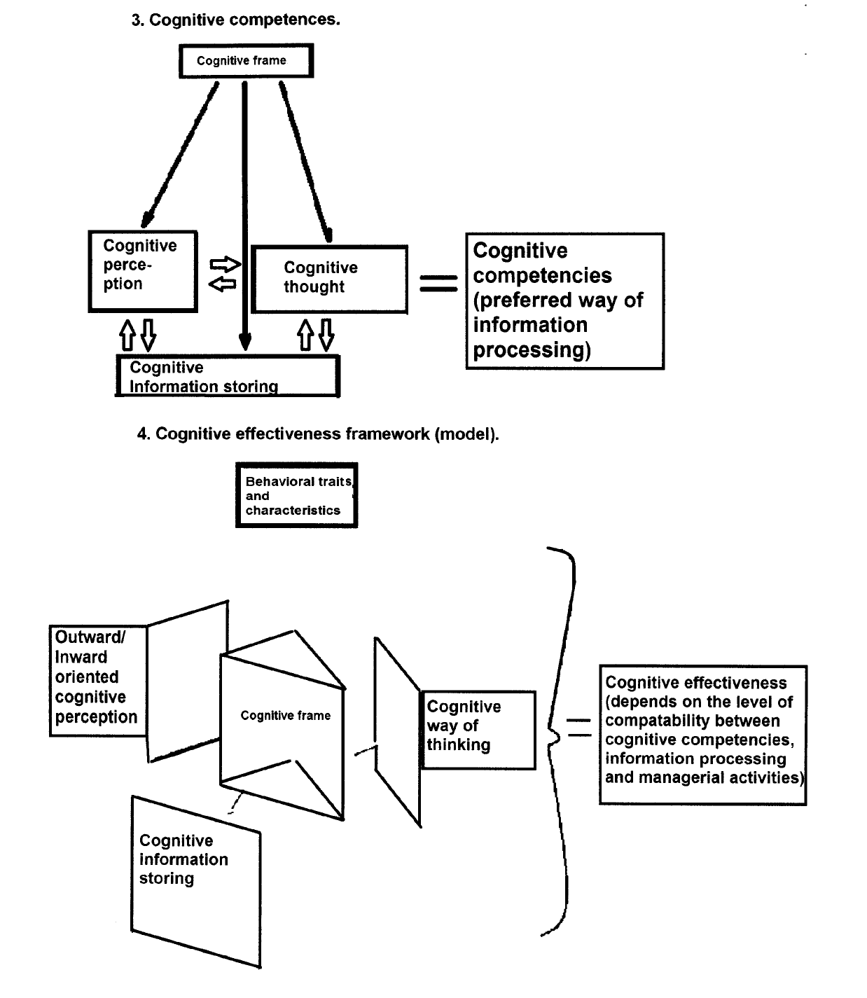

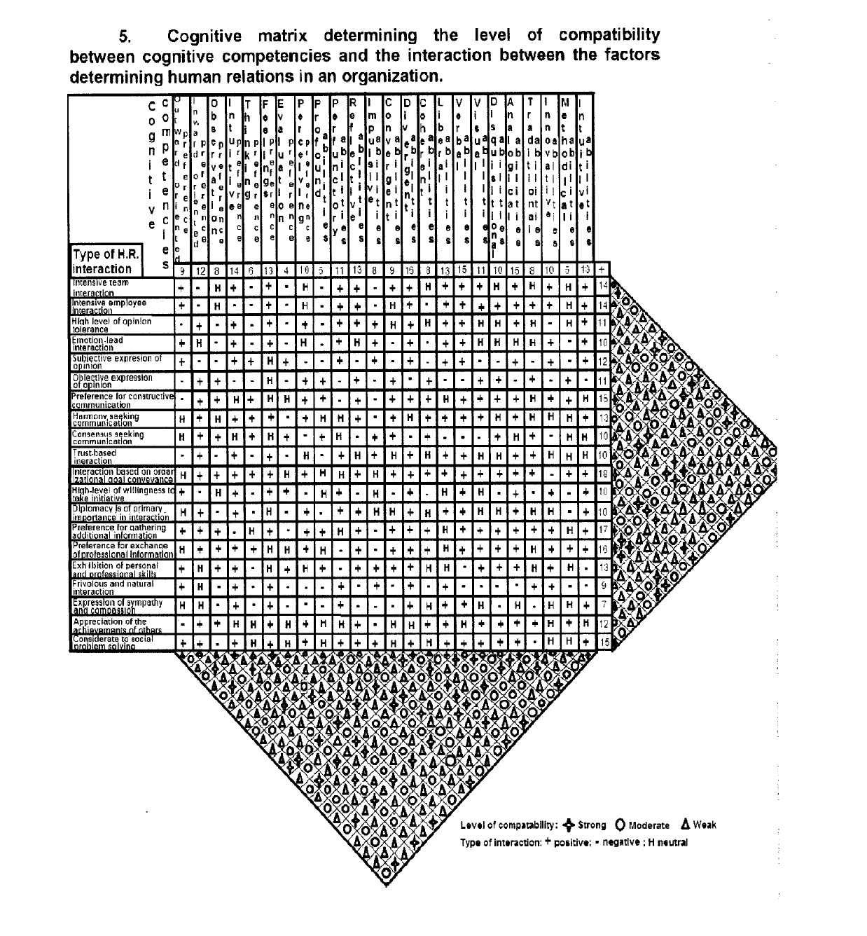

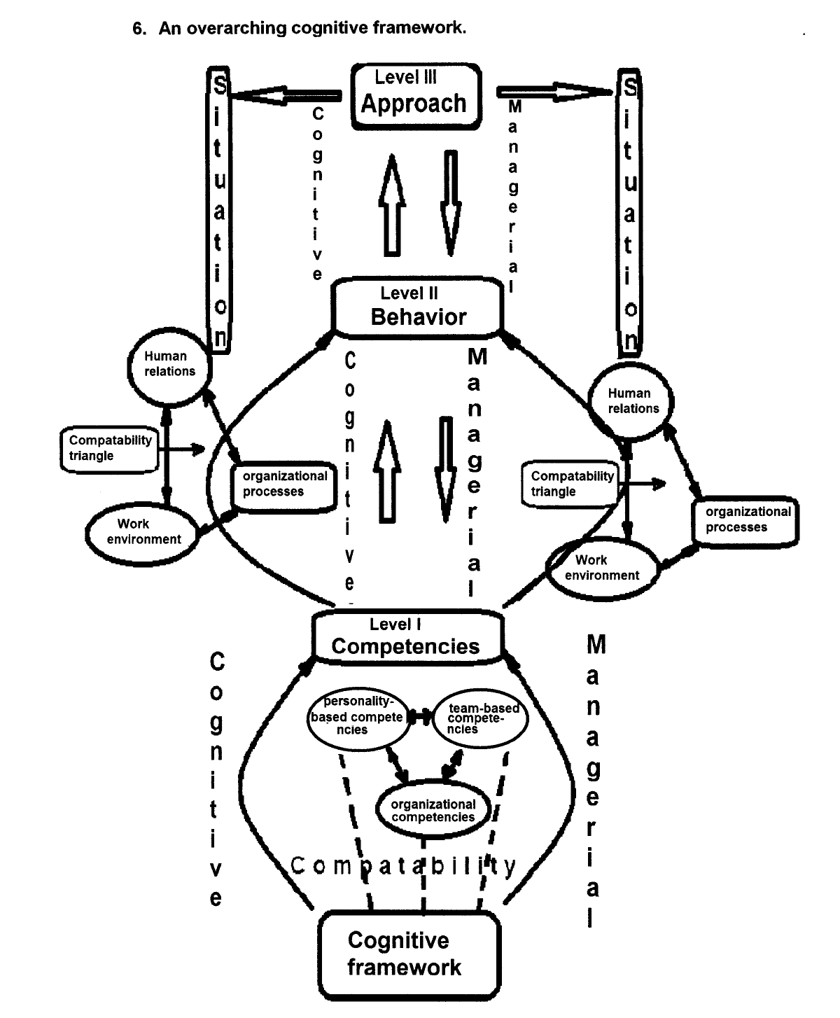

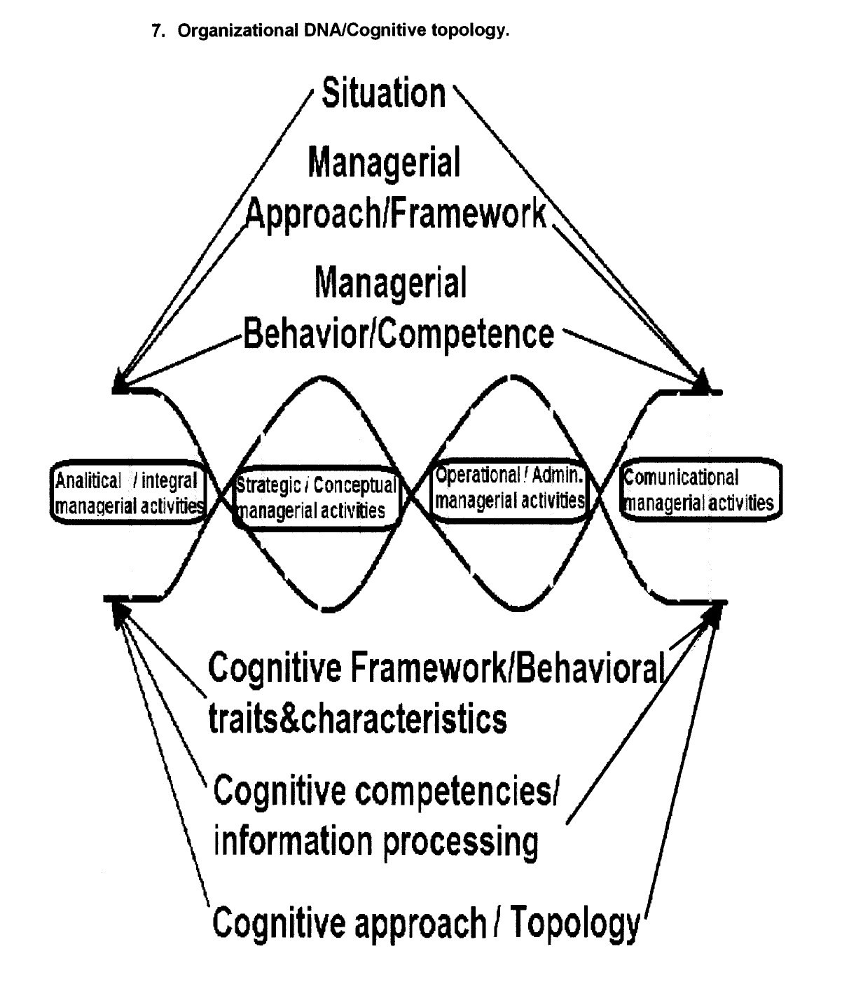

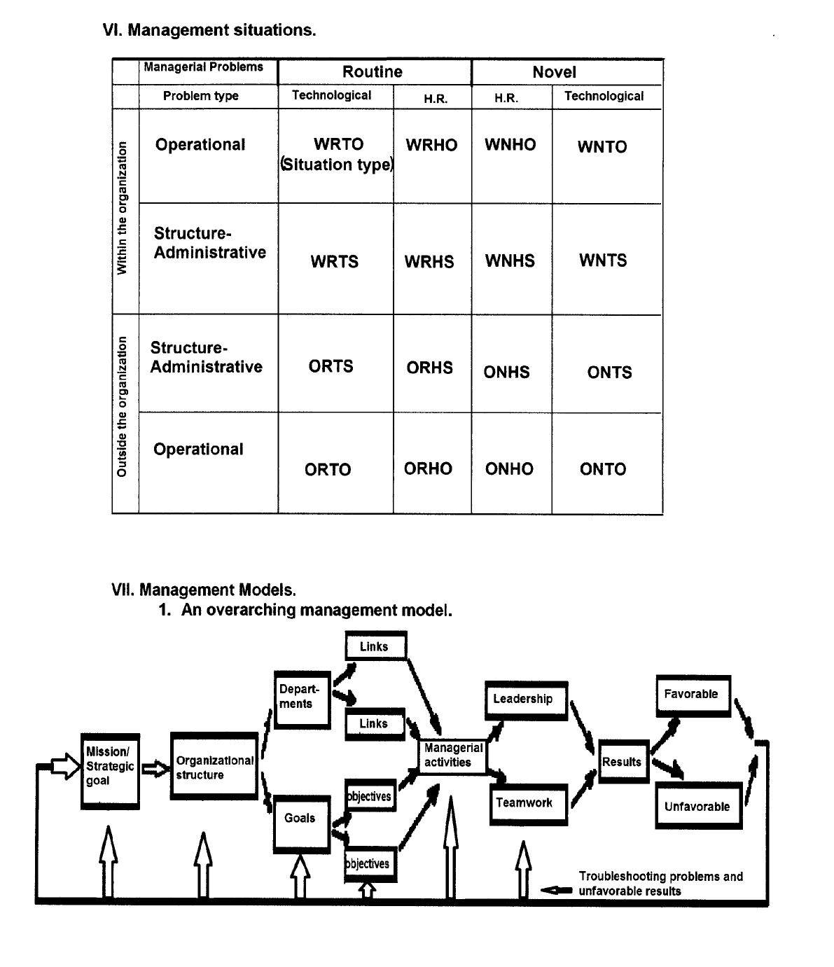

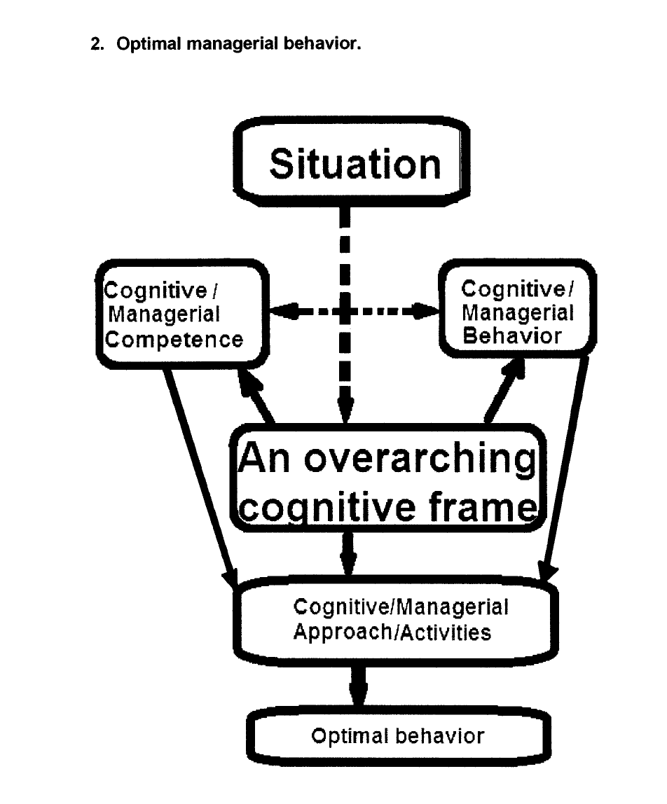

Cognitive topology seeks to reveal the level of compatibility between managerial/cognitive competencies and managerial activities in various business situations. Such an approach enables organizations to enhance the level of managerial performance and optimize organizational behavior. In addition, it helps organizations to determine the level of risk associated with the implementation of various managerial activities. This is accomplished by determining the level of managerial performance in different business situations (see drawings p. 28, section IV). In view of the set business goals and objectives, Cognitive topology helps organizations to adapt, transform and/or react to changes in both its internal and external business environment. Thus it helps organizations to enhance managerial efficiency and drive organizational sustainability.

The first step in the development of Cognitive topology is advanced by determining individual cognitive competencies cognitive abilities and cognitive preferences. This is achieved by examining the nature of cognitive functioning (the way a person perceives, stores and processes information). Basically, this method proposes 16 different mind frames (see drawings p. 3, sec. A & B; p. 5 sec. A; p. 6 sec. B; p. 8 sec. A & B; p. 10 sec. A; p. 11 sec. B; p. 13 sec. A & B; p. 15 sec. A; p. 16 sec. B; p. 18 sec. A & B; p. 20, sec. A; p. 21 sec. B), which lead to optimal managerial performance/results in the implementation of 16 managerial activities (see drawings p. 4, sec. C & D; p. 6 sec. C; p. 7 sec. D; p. 9, sec. C & D; p. 11 sec. C; p. 12 sec. D; p. 14 sec. C & D; p. 16 sec. C; p. 17 sec. D; p. 19 sec. C & D; p. 21 sec. C; p. 22, sec. D). The key indicators which determine the performance level in various managerial activities are the proposed/developed behavioral features and characteristics. To a great extend the constellation/balance between the proposed 23 behavioral features and characteristics determine the level of compatibility between the specified cognitive abilities and managerial activities.

The second step in the development of this new methodology is advanced by creating a model for interpreting of new-coming information (see drawings p. 23, sec V(1). This model is important because of both it illustrates the nature of the cognitive categories that take part in the decision-making process and determines their role in the process of perceiving, storing and processing information. Based on the ingrained behavioral traits and characteristics this model helps us determine what environmental/informational input leads to what type of behavioral output.

The third step in the development of Cognitive topology is implemented by proposing a framework for cognitive effectiveness (see drawings p. 24, sec. 4). This framework helps organizations determine the level of compatibility between cognitive and behavioral functioning. It is proposed that the level of managerial/organizational efficiency depends on the level of compatibility between cognitive abilities and preferences, on the one hand, and the nature of managerial competencies and activities implemented in the organization, on the other hand. The proposed level of compatibility is determined by the matrix of cognitive compatibility (see drawings p. 25, sec 5). This matrix examines the interaction between cognitive competencies and the factors influencing human relations in the organization.

In view of the above models and matrix, the fourth step in the development of Cognitive topology is advanced by determining the level of compatibility between cognitive competencies and managerial behavior in 3D organizational environment human relations, work setting and organizational processes. This is achieved by studying the relationship and level of compatibility between cognitive competences, on the one hand, and managerial competencies personality based competences, team based competencies and organizational competencies of the managerial staff, on the other hand (see drawings p. 26 sec. 6).

The final step in creating Cognitive topology is advanced by prescribing the optimal managerial/organizational behavior in 16 different managerial situations. This is achieved by determining the key cognitive and managerial competencies attributed to these situations (see drawing p. 27, sec. 7). As a result, the methodology extends practical recommendations that improve organizational performance, facilitate managerial effectiveness and drive organizational sustainability.

1. Cognitive topology is a methodology that enables managerial staff and organizations to:
1. Advance a new 3D (dimensional) managerial perspective. This perspective takes into consideration cognitive and managerial competencies in three dimensional organizational setting/environment human relations, work setting and organizational processes. It studies the level of compatibility between these competencies by studying the key factors underlying personality, team and organizational managerial behavior;
2. It helps to create a DNA model of organizational performance. In particular, it examines the balance of managerial activities that leads to optimal organizational/managerial behavior in various managerial situations;
3. It leads to a healthier, more efficient and sustainable business development. In particular, this methodology helps identify the level of compatibility between cognitive and manager competencies. Thus it helps management to access the risk of the human factor in view of the proposed managerial goals and objectives.
4. It determines the optimal course of managerial/organizational action in various managerial situations.
5. It reveals management potential to perform in various organizational settings and reduces managerial stress level, while improving organizational efficiency and effectiveness.
6. Helps organizations to understand how cognitive functioning is transformed into effective and sustainable managerial/organizational behavior.
7. Improves organizational design by identifying the optimal organizational structure and facilitates team building efforts.
